(19) United States
(12) Patent Application Publication
(10) Pub. No.: US 2004/0196147 A1
(43) Pub. Date: Oct. 7, 2004

(54) Tire Management System

(76) Inventor: George Albuquerque, Bayville, NJ (US)

Correspondence Address: GEORGE ALBUQUERQUE, 36 BELMONT AVE, BAYVILLE, NJ, 08721, US

(21) Appl. No.: 10/249,404

(22) Filed: Apr. 7, 2003

(51) Int. Cl. B60C 23/00

(52) U.S. Cl. 340/442

(57) ABSTRACT

The invention claims by placing a minimum of five temperature sensors either embedded in the tire tread above or under the radial or carcass during manufacturing, or affixing a minimum of three temperature sensors in a particular configuration to the inside of the tire above or beneath the radial cord, measurements can be taken and transmitted to an end user device which can interpret the readings and conclusions can be drawn as to the condition of the vehicle setup and pressure as it pertains to the tire condition of each tire on the vehicle simultaneously as the vehicle is moving at slow or high speeds.

### DESCRIPTION OF RELATED ART

Various tire temperature measurement and monitoring systems have been devised for cars and trucks to provide warnings for blowouts or for ensuring performance on the race track or long distance hauling. Important problems of these systems are or have been the mounting of sensors close enough to the tire or tread wall inside the tire, providing sensor information from more than one area of the tire and communication of the multiple sensor data from multiple tires to central locations for monitoring and processing such data in an organized manner. U.S. Printed publication 2002/0130771 published on Sep. 19, 2002 to Osbourne et al. discloses the utilizing of a single sensor inside the tires of a vehicle to transmit temperature data from the tires to a computer-processing hub located within the vehicle and displayed for the driver. However, this reference only uses one sensor per tire rather than multiple temperature sensors mounted in different zones of a tire in a multiple tire system as solved by the present invention. Also, this reference lacks sophistication to organize and multiple sensors inside each tire at different locations and the output from each tire. This reference provides temperature monitoring while stationary or moving; therefore, the system in this reference uses more power. Also, this reference collects stationary temperature data that is less useful than when moving as in the present invention. U.S. Pat. No. 5,055,245 issued on Oct. 8, 1991 to Hisatomi et al. discloses a temperature sensor arranged in several different regions of a tire including the inner 6, outer 8 and middle 7 portions. The temperatures in each of the regions are monitored. However, in this reference these temperatures are monitored either before, during or after vulcanization of the tire and not while the tires are mounted on the car while on the road and moving as in the present invention. This reference also lacks the sophistication to organize and ID the temperature data from more than one tire having multiple temperature sensors in specialized locations as in the present invention. U.S. Pat. No. 6,259,361 issued on Jul. 10, 2001 to Robillard et al. discloses a tire condition monitoring system that uses a temperature sensor to remotely transmit temperature data to a receiver for display. The system in this reference also uses only one temperature sensor per tire and provides an indirect means or accelerometer to identify the location of the single tire temperature data received. Also, this reference provides mostly pressure data and blow-out information. Therefore, this reference also lacks the sophistication to organize and ID the temperature data from more than tire having multiple temperature sensors in specialized locations as in the present invention. U.S. Pat. No. 5,708,411 issued on Jan. 13, 1998 to Hill discloses a tire monitoring system using a sensor-transmitter unit inside of each tire and a central receiver. This reference does obtain temperatures from multiple locations from within the tire, because it is allowed to move freely inside the tire. However, this reference cannot obtain temperatures from multiple fixed locations simultaneously as in the present invention, since this reference uses only one sensor module inside an individual tire that moves freely. U.S. Pat. No. 6,243,007 issued on Jun. 5, 2001 to McLaughlin, et al. discloses a tire monitoring system using a single sensor-transmitter unit inside of each tire and a central receiver. This reference uses both a motion detector and pressure sensor in the sensor transmitter unit to save power during periods of vehicle inactivity. Also, in this reference the sensor-transmitter is mounted at a single fixed location not located on the tire tread wall. The present invention uses multiple fixed location sensors located on special locations on the tire tread walls. The following documents further illustrate the prior art in the field of sensors for automobile tires: U.S. Patent publication 2001/0008083 published on Jul. 19, 2001 to Brown; U.S. Patent publication 2001/005060611 published on Dec. 13, 2001 to Acherterholt; U.S. Patent publication 2002/0039066 published on Apr. 4, 2002 to Fuller et al.; U.S. Patent publication 2002/0092364 published on Jul. 18, 2002 to Adderton et al.; U.S. Patent publication 2002/0095980 published on Jul. 25, 2002 to Breed et al.; U.S. Patent publication 2002/0126005 published on Sep. 12, 2002 to Hardman et al.; U.S. Pat. No. 6,407,662 issued on Jun. 18, 2002 to Gomez De Sebastian; U.S. Pat. No. 6,486,771 issued on Nov. 26, 2002 to Fuller et al.; Japan Patent No. 1,113,211 on 05/1989 and German Patent No. 42 24 498 on 01/1994. Therefore, it would be desirable to provide a tire temperature measuring and monitoring system to monitor temperatures at multiple fixed zones on the inside tire walls of plural tires using identification and organization of multiple temperature data streams from the remote tire locations to a central hub using microprocessors, transmitters, receivers and display devices and other electronics. It would also be desirable to provide a tire temperature measuring and monitoring system wherein the temperature sensors or thermistors are close enough to the metallic radials cords embedded in the tire to calculate the temperature of the metal cords embedded in the tire wall. None of the above inventions and patents, taken either singularly or in combination, is seen to describe the instant invention as claimed. Thus a system of sensors to measure tire heat solving the aforementioned problems is desired.

### BACKGROUND OF INVENTION

It is established in the automobile racing industry that the use of hand held pyrometer will determine the temperatures of the tire tread close to the radial cord at three specific zones only after the vehicle is stopped. These temperatures, when calculated can make the driver and pit crew aware of specific problems that is wrong with the tire pressure, camber, tow-in, tow-out, springs, and shocks. This present invention will now allow the same calculations as the vehicle is stationary or as the vehicle is in motion at slow or high speeds.

### SUMMARY OF INVENTION

This invention, the temperature sensors, when embedded or affixed to a tire, will give determine tire pressures and temperatures as well as automobile alignment problems that arise from a vehicle as it is in motion. The response will be instantaneous as the transmitted frequencies or signals from the three temperature sensors are sent to a receiver that will compile, analyze and display data to an display device. Radio or microwave frequencies or signals are interpreted and displayed on a display device to show the condition of the individual tire and the condition of the balance of the tire as well as the condition of the alignment and chassis setup of a vehicle.

The present invention is a tire temperature measuring and monitoring system to measure temperatures at multiple, fixed, strategic sensor locations embedded into the tire tread or on the inside tire walls of all tires on a vehicle using identification, organization and transmission of multiple temperature data streams from the tire sensor locations, using thermistors, IC temperature circuits, processing circuitry, microprocessors, transmitters, receivers and display devices.

It is another object of the invention to provide a tire temperature measurement and monitoring system having circuitry inside the tire to identify and organize the temperature data from three or more sensors inside the tire.

Still another object of the invention is to provide a tire temperature measurement and monitoring system, which enables the driver, mechanics, pit crew and/or engineers at a vehicle testing center to monitor tire tread temperatures in multiple zones on one or more tires of a moving vehicle simultaneously.

It is another object of the present invention to read the temperatures of the tire side walls of the tire as the vehicle is in motion.

These and other objects of the present invention will become readily apparent upon further review of the following specification and drawings.

All information this invention gathers and transmits can be obtained from the use of a pyrometer and is stated within with the exception that the readings will be obtained instantaneously as the vehicle is driving or in motion.

### BRIEF DESCRIPTION OF DRAWINGS

FIG. 1 shows the locations of the temperature sensors embedded under cord within the tire and on the side walls.

FIG. 2 shows alternate locations of temperature sensors embedded above the cord within the tire and the side walls.

FIG. 3 shows alternate locations of temperature sensors affixed to the inside of the tire tread as a patch or other affixed methods and the side walls.

FIG. 4 shows the specific locations the temperature sensors would be located to relation to the tire tread, side walls, and to each other.

### DETAILED DESCRIPTION

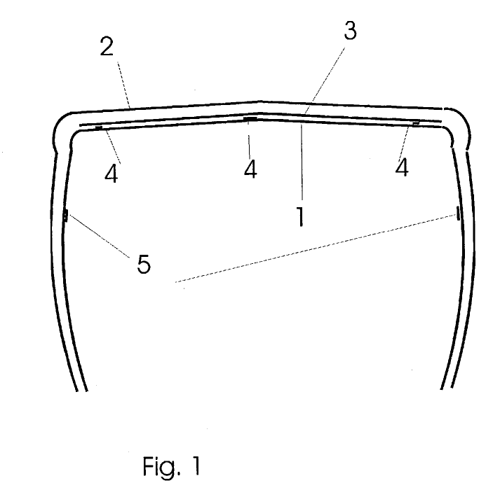

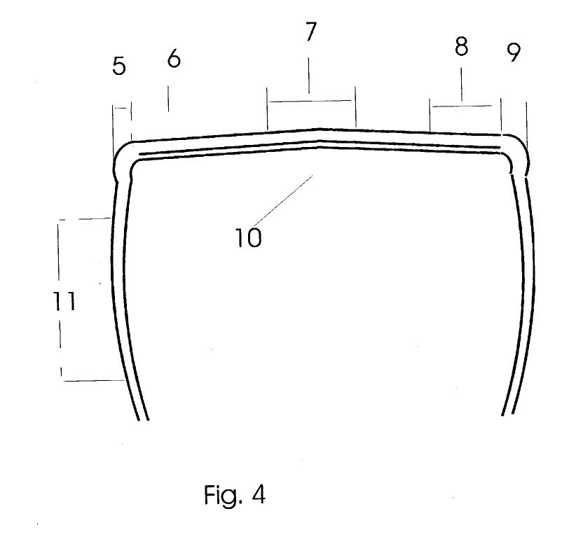

FIG. 1 claims this invention is comprised of a minimum of three temperature sensors 4 embedded in the tread 2 under the radial cord 3. When these sensors are located at the inner 6, middle 7, and outer 8 tread shown in FIG. 4, readings can calculate the heat build up at the three zones separately, then each reading is combined to show the temperature condition of the tire and the relationship of the vehicle to the road surface. The side wall temperature sensors 5, at the desired locations shown in FIG. 4, 11 are allowing the tire side wall temperatures to be read and interpreted, showing the stress of a tire side wall as the vehicle is in motion at slow and high speeds.

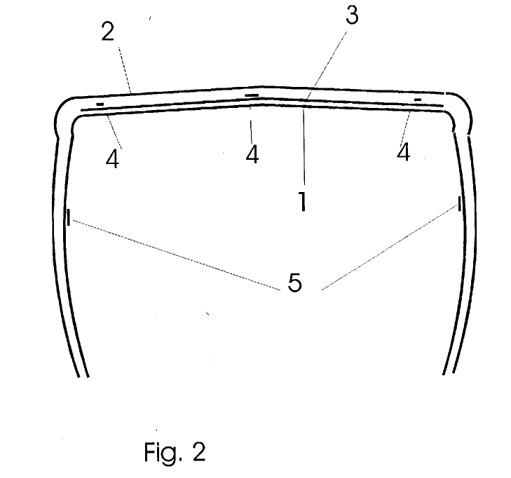

FIG. 2 is the same invention only the temperature sensors 4 are embedded in the tread 2 above the cord 3 yet still within the parameters of 6, 7 and 8 shown in FIG. 4. In addition the side wall 17, FIG. 4 temperature sensors 5 are at the desired locations.

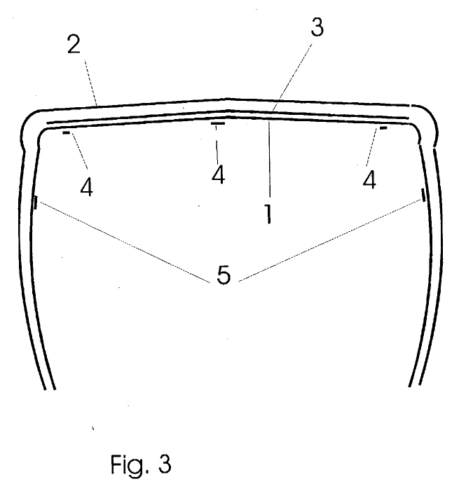

FIG. 3 is the same invention only the temperature sensors 4 are attached with adhesive or other attaching device inside the tire 1 under the cord 3 still within the parameters of 6, 7 and 8, shown in FIG. 4. In addition the side wall 11, FIG. 4 temperature sensors 5 are at the desired locations.

FIG. 1, FIG. 2, and FIG. 3 claims when the heat from the temperature sensors 4 are higher in temperature at the inner 6 and outer 8 tread zones than the middle 7 tread zone shown in FIG. 4, it becomes clear that the tire pressure is low. The relationship between air pressure and temperature will be determined by individual tire manufacturer and through testing.

FIG. 1, FIG. 2, and FIG. 3 claims when the heat from the temperature sensors 4 are higher in temperature in the middle 7 tread zone and lower in temperature at the inner 6 and outer 8 tread zones shown in FIG. 4, it is clear that the tire pressure is high. The relationship between air pressure and temperature will be determined by individual tire manufacturer and through testing.

FIG. 1, FIG. 2, and FIG. 3 claims when the temperature sensors 4 at the inner 6 and middle 7 tread zones are higher in temperature than the outer 8 tread zone shown in FIG. 4, it is evident that the vehicle camber is negative or other alignment problems are occurring.

FIG. 1, FIG. 2, and FIG. 3 claims when the temperature sensors 4 are higher in temperature at the outer 8 and middle 7 tread zones than the inner 6 tread zone shown in FIG. 4 the vehicle camber is positive or other alignment problems are occurring.

FIG. 4 shows the distance from the edge of the tire tread that begins placement of temperature sensor 4 depicted in FIG. 1, FIG. 2, and FIG. 3. The width of 5 and 9 is one half inch or 12.5 mm from the extreme edge of tread surface.

FIG. 4 shows the distance of the temperature sensor 4 depicted in FIG. 1, FIG. 2 and FIG. 3 is the crucial placement at the outer 8 and inner 6 edges which falls within a distance of 0-3 inches or 0-760 mm from the starting points of 5 and 9.

FIG. 4 shows the placement of the temperature sensor 4 depicted in FIG. 1, FIG. 2 and FIG. 3 at the middle 7 tread zone of the tire center line 10 is between 0-1.5 inches or 0-380 mm to each side of the tire center line 10.

FIG. 1, FIG. 2, and FIG. 3 show added temperature sensors 5 added to the three main temperature sensors 4 allowing additional information data transfer to the end user for analysis.

FIG. 4 show the side wall locations 11 for temperature sensors 5.

The present invention in conjunction with other devices will also calculate many other tire temperature malfunctions and mechanical problems that may go wrong with alignment and chassis as the vehicle is in motion.

1. I claim the present invention allows the tire tread to be read with embedded or affixed temperature sensors across a minimum of the three crucial tread zone at the radial cords and two side wall locations that are adjacent to each other. These measurements when compiled and analyzed, will determine the tire pressure, tire configuration, tire balance, tire condition, side wall stress and vehicle alignment as the vehicle is in motion at slow or high speeds.

2. As claim 1 indicates temperature sensors are units that may be any embedded or affixed electronic, nano-tech, micro, or electro mechanical temperature sensors.

3. As claim 1 depicts the temperature sensors may be individual temperature sensors working together or affixed on a IC substrate or wired together.

4. With claim 1 the camber, springs, tow, shocks or other vehicle alignments can be determined to be in or out of alignment.

5. Claim 1 will indicate the air pressure of the tire is too high or too low according to the temperature calculations.

6. With claim 1 the temperature of the tread will be read in minimum of three tread zones and two side wall locations, when combined will calculate numerous functions other than tire pressure and vehicle alignment and side wall stress.

7. I claim that any display device used to produce the results of the calculations of the five sensors stated, either digital, analog, lights or another form of display are the results of the use of the invention stated in claim 1.

8. It is with claim 1 that all embedded or affixed devices used to determine tire condition, malfunction, pressure, wear, or any other tire measuring calculation using the three tread zones and two tire side walls as the crucial placement is the claim of this invention.
